(19) United States
(12) Patent Application Publication
(10) Pub. No.: US 2019/0279605 A1
(43) Pub. Date: Sep. 12, 2019

(54) Interchangeably Portable and Pliable Music Instrument Case

(71) Applicant: MANAGEMENT PARTNERS LLC, Beckley, WV (US)

(72) Inventor: Suzanne Parker, Los Angeles, CA (US)

(21) Appl. No.: 16/297,547

(22) Filed: Mar. 8, 2019

Related U.S. Application Data
(60) Provisional application No. 62/640,367, filed on Mar. 8, 2018.

(51) Int. Cl. G10G 7/00

(52) U.S. Cl. CPC G10G 7/005

(57) ABSTRACT

An interchangeably portable and pliable music instrument case is defined by a pliable body that receives and securely encapsulates a music instrument. The music instrument case is molded to a desired musical instrument shape, such as a guitar, drum, wind instrument, a brass instrument, or percussion instrument. The music instrument case comprises a soft body portion fabricated substantially from a soft shell material, including: polypropylene foam, air bladder, water bladder, soft polymer, cotton, mesh material, and flexible materials. This allows the instrument to be transported as carry-on baggage, i.e., plane. The music instrument case further includes at least one mobility member, such as a wheel, a skid, and a hover mechanism, that are interchangeable and detachably attach to the body to accommodate different transport needs. A pair of rails and a slidable arm extend and retract to provide a gripping surface for facilitated transport of the music instrument case.

### CROSS REFERENCE OF RELATED APPLICATIONS

This application claims the benefits of U.S. provisional application No. 62/640,367, filed Mar. 8, 2018 and entitled SOFT MUSIC INSTRUMENT CASE WITH INTERCHANGEABLE MOBILITY MEANS, which provisional application is incorporated by reference herein in its entirety.

### FIELD OF THE INVENTION

The present invention relates generally to an interchangeably portable and pliable music instrument case. More so, a music instrument case has a pliable body that receives and securely encapsulates a music instrument, such that the instrument can be transported as portable baggage; and further includes at least one mobility member, such as a wheel, a skid, and a hover mechanism, that are interchangeable to accommodate different transport needs; and further comprises a pair of rails and a slidable arm that ride the rails to extend and retract, so as to provide a gripping surface for carrying the music instrument case.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, music instrument cases are widely used to store, protect, and carry musical instruments. The music instrument case is generally shaped to match the specific musical instrument being carried. For example, in the case of stringed musical instruments, such as guitars, the music instrument case is an elongated structure having a wide base and a narrow neck region. Such a guitar case is often hinged lengthwise to enable positioning of the guitar in the mold.

It is also known in the art that musicians travel from venue to venue to play their instruments. The great majority of these musicians must carry their own instruments to and from each show. In order to protect the instruments during travel most musicians place them in some type of protective case. However, if the case is hard, airlines usually require the case to be carried in the hold of the airplane. Unfortunately, the rough handling of baggage and freight in the hold of the airplane can damage a sensitive musical instrument, making it undesirable to place the instrument case in the hold.

Other proposals have involved musical cases for traveling with a musical instrument. The problem with these musical cases is that they are not soft enough to qualify as a carry-on luggage. Also, the mobility means, if any, are limited to one type, such as wheels. Multiple types of mobility means are not always present. Even though the above cited musical cases meet some of the needs of the market, an interchangeably portable and pliable music instrument case that receives and securely encapsulates a music instrument, such that the instrument can be transported as carry-on baggage; and further includes at least one mobility member, such as a wheel, a skid, and a hover mechanism, that are interchangeable to accommodate different transport needs; and further comprises a pair of rails and a slidable arm that ride the rails to extend and retract, so as to provide a gripping surface for carrying the music instrument case, is still desired.

### SUMMARY

Illustrative embodiments of the disclosure are generally directed to an interchangeably portable and pliable music instrument case is defined by a pliable body that receives and securely encapsulates a music instrument. The music instrument case is molded to a desired musical instrument shape, such as a guitar, drum, wind instrument, a brass instrument, or percussion instrument. The music instrument case comprises a soft body portion fabricated substantially from a soft shell material, including: a resilient material, a polypropylene foam, an air bladder, a water bladder, a soft polymer, cotton, mesh material, and flexible materials. This allows the instrument to be transported as portable baggage.

This allows the instrument to be transported as carry-on baggage, i.e., plane, cruise ship. The music instrument case further includes at least one mobility member, such as a wheel, a skid, and a hover mechanism, that are interchangeable and detachably attach to the pliable body portion, so as to accommodate different transport needs. A pair of rails and a slidable arm extend and retract from the body portion to provide a gripping surface for facilitated transport of the music instrument case.

In one aspect, the music instrument case, comprises a pliable body portion defined by a top end, a bottom end, and a sidewall having an outer surface and an inner surface. The sidewall forms an inner depression, which may be fabricated from a soft shell material. The body portion is further being defined by a lid that is operable to move between an open position and a closed position to regulate access to the inner depression. The body portion further comprises a soft shell material, or other pliable material that allows for carry-on status on airplanes, trains, and the like.

In some embodiments, the music instrument case may include an instrument support frame disposed in the inner depression. The instrument support frame comprises a pair of fastening support members and a pair of rails.

In some embodiments, the music instrument case may include an arm defined by a first end and a second end. The arm slidably rides the rails. The arm is extendable and retractable to selectively extend and retract through the body portion. In this manner, the arm enables facilitated transport of the body portion. A handle joins with the first end of the arm.

In some embodiments, the music instrument case may include a cradle that joins the instrument support frame. The cradle is defined by an arced section that is shaped and dimensioned to receive a musical instrument. The cradle is further defined by a pair of feet that help maintain the musical instrument at a level disposition.

In some embodiments, the music instrument case may include an external fastening brace disposed at the bottom end of the body portion. The music instrument case may also include a plurality of mobility members that are detachably attachable to the external fastening brace. The mobility members are interchangeable on the body portion of the music instrument case.

In another aspect, the musical instrument can be selected from a group consisting of: a guitar, a bass, a drum, a wind instrument, a brass instrument, a percussion instrument, a string instrument, keyboards, amplifiers, speaker, synthesizers, mixing desk, equalizer and other rack effects, Mic cable, snake cables, wireless systems, media players, subwoofer, condenser, drum Mics, wireless Mics, Mic stands, phone and tablet clips, and maintenance tools.

In another aspect, the molded depression is defined by a wide end and a narrow neck end.

In another aspect, the soft shell material of the resilient body portion 102 includes at least one of the following: a polypropylene foam, an air bladder, a water bladder, a soft polymer, cotton, mesh material, and flexible materials.

In another aspect, the mobility member includes at least one of the following: at least one wheel, pair of skis, a hover mechanism, a slide mechanism, a skid, and rollers.

One objective of the present invention is to provide a musical instrument case that has a pliable sidewall, so that the musical instrument can be carried as a carry-on luggage on an airplane, cruise ship, train, and the like.

Another objective is to provide a body portion that is constructed from a material that is soft, flexible and meets the criteria of carry-on for travel.

Another objective is to provide a protective case that encapsulates the guitar, or other musical instrument.

Another objective is to provide wheels, skids, rollers, and hovering means that allow the music instrument case to be easily pulled or pushed.

Another objective is to provide an extendable arm with handle that can be used to pull the music instrument case.

Another objective is to provide a music instrument case that is inexpensive to manufacture.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a front perspective view of an exemplary interchangeably portable and pliable music instrument case, in accordance with an embodiment of the present invention;

FIG. 2 illustrates a rear perspective view of the music instrument case shown in FIG. 1, in accordance with an embodiment of the present invention;

FIG. 3 illustrates a top view of the music instrument case shown in FIG. 1, showing the interior of the body portion, in accordance with an embodiment of the present invention;

FIG. 4 illustrates a perspective view of a second embodiment of the interchangeably portable and pliable music instrument case, shaped to receive a guitar, in accordance with an embodiment of the present invention;

FIG. 5 illustrates a perspective view of an exemplary instrument support frame of the music instrument case, in accordance with an embodiment of the present invention;

FIG. 6 illustrates a perspective view of an exemplary cradle, showing an arced section and a pair of feet, in accordance with an embodiment of the present invention;

FIG. 7 illustrates an elevated side view of the cradle shown in FIG. 6, in accordance with an embodiment of the present invention;

FIG. 8 illustrates a perspective view of an exemplary external fastening brace for fastening at least one interchangeable mobility member to the body portion of the music instrument case, in accordance with an embodiment of the present invention;

FIG. 9 illustrates a perspective view of an exemplary wheel, represented by a castor wheel, and attached to the external fastening brace, in accordance with an embodiment of the present invention;

FIG. 10 illustrates a perspective view of an exemplary pair of skis attached to the external fastening brace, in accordance with an embodiment of the present invention;

FIG. 11 illustrates a perspective view of an exemplary hover mechanism attached to the external fastening brace, in accordance with an embodiment of the present invention; and

FIG. 12 illustrates a perspective view of an exemplary sliding mechanism attached to the external fastening brace, in accordance with an embodiment of the present invention.

Like reference numerals refer to like parts throughout the various views of the drawings.

### DETAILED DESCRIPTION OF THE INVENTION

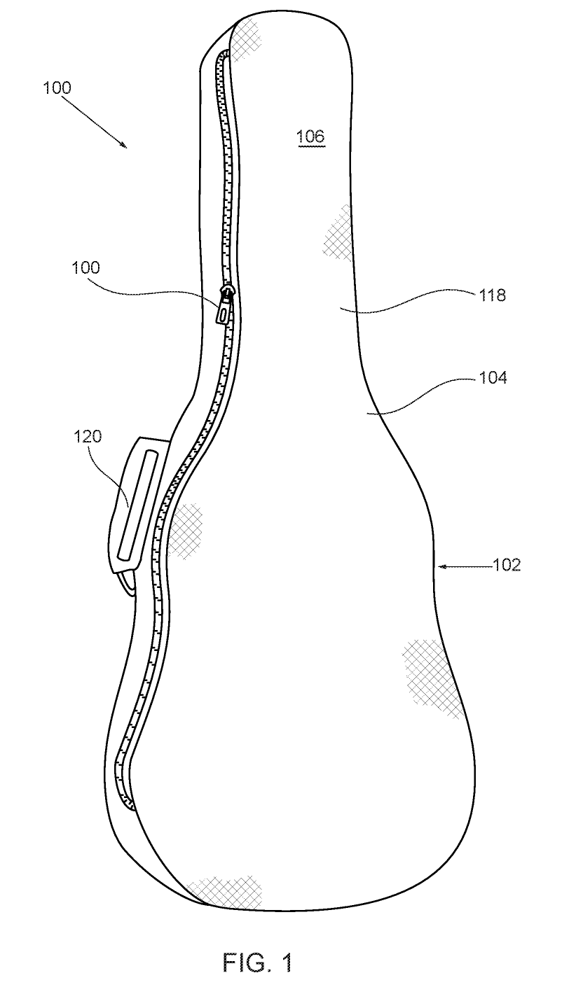

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-12, an interchangeably portable and pliable music instrument case is unique in providing a body portion that is pliable; and thereby sufficiently flexible to both receive a musical instrument, and meet the criteria for portable baggage, as set by most airlines, cruise ships, trains, etc, known in the art.

The music instrument case 100 further includes a plurality of interchangeable mobility members 116a-d, such as a wheel, a skid, and a hover mechanism, that are interchangeable and detachably attach to the pliable body portion, so as to accommodate different transport needs. The mobility members are eclectic enough to accommodate different types of surfaces and weights of musical instruments during travel. A pair of rails and a slidable arm extend and retract from the body portion to provide a gripping surface for facilitated transport of the music instrument case.

Specifically, the interchangeably portable and pliable music instrument case, hereafter “music instrument case 100” is configured to protectively encapsulate and cushion a musical instrument, such as a guitar, which is fully assembled. In this manner, a user only has to carry and open the music instrument case 100 to utilize the music instrument. And significantly, the soft music instrument case 100 is sufficiently flexible and resilient, such that it can be carried on to an airplane, rather than being put in the hold.

As referenced in FIG. 1, the music instrument case 100 is defined by a pliable body portion 102 that receives and securely encapsulates a musical instrument (not shown). The music instrument case 100 is molded to a desired musical instrument shape to receive and snugly retain the musical instrument. For example, the musical instrument may include a guitar that fits into a guitar-shaped instrument case. Though in other embodiments, the musical instrument contained in the body portion 102 may include, without limitation, a drum, a wind instrument, a brass instrument, a percussion instrument, and a string instrument. Though the body portion 102 may be configured to accommodate any musical instrument known in the art.

In some embodiments, the body portion 102 is defined by a top end 122a and a bottom end 122b. The music instrument case 100 is fabricated substantially from a soft shell material composition, may include, without limitation, a resilient material, a polypropylene foam, an air bladder, a water bladder, a soft polymer, cotton, mesh material, and flexible materials.

In other embodiments, the music instrument case 100 is molded to a desired musical instrument shape, which may include a guitar, drum, wind instrument, a brass instrument, or percussion instrument. Because of the soft configuration of the music instrument case 100, it can be carried as portable baggage on an airplane, rather than in the hold, as with hard bodied baggage and cases.

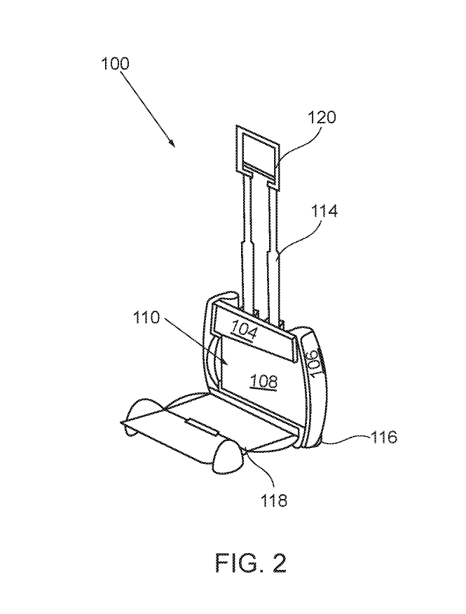

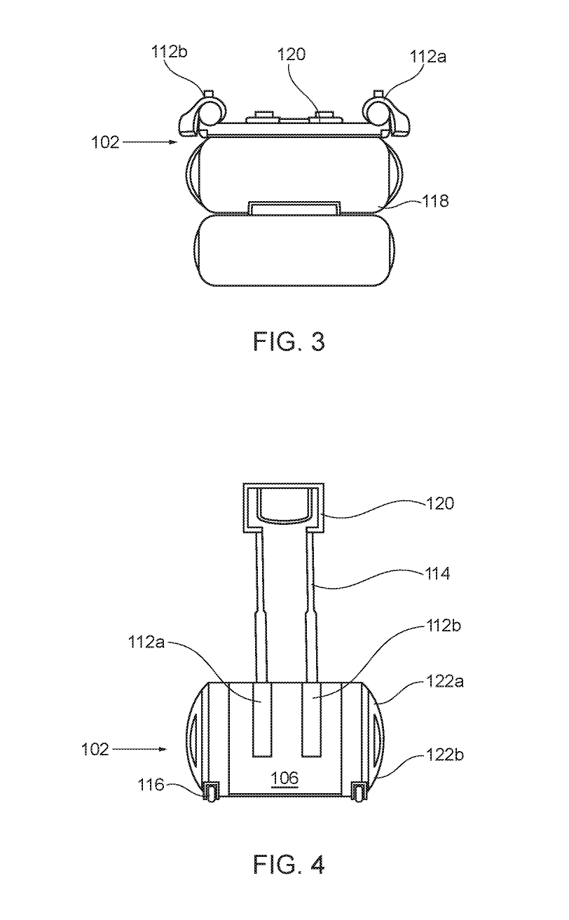

Further, the body portion 102 is defined by a sidewall 104 having an outer surface 106 and an inner surface 108. The sidewall 104 forms an inner depression 110. The body portion 102 is also defined by a lid 118 that is displaceable between an open position 138 (FIG. 1), and a closed position 140 (FIG. 2). The lid 118 enables a user to regulate access to the inner depression 110 for insertion, removal, and manipulation of the musical instrument. The lid 118 may hingedly or slidably move between the open and closed positions 138, 140 to regulate access to the inner depression 110. In one non-limiting embodiment, the lid 118 hinges at a central location to create greater flexibility (FIG. 3).

In alternative embodiments of the present invention, the body portion 102 may be constructed from a rigid material. This section of the body portion 102 has to be hard to support the soft, protective part of the inner surface 108. Thus, in this alternative configuration, the body portion 102 is defined by a hard outer surface 106, a soft inner surface 108, and an inner depression 110 shaped and dimensioned to receive a musical instrument. Thus, both the outer and inner components are resilient and flexible to serve as cushions and enable carry-on status on an airplane. Further, the inner depression 110 can be configured to accommodate any number of musical instruments.

In any manner, the pliable material composition of the body portion 102 serves as a cushion for the musical instrument, and also allows the musical instrument to be carried onto the airplane, rather than put in the hold of the airplane. It is known in the art that stringed instruments, in general, are trapezoidally-shaped with wide bases and narrow necks. Accordingly, carrying cases for these instruments have a similar arrangement and, when more than one instrument case has to be carried by a musician, it results in a bulky, awkward load to be carried.

For example, the body portion 102 of the music instrument case 100 receives a guitar through an inner depression having a narrow neck region and a wide body region. Quite differently, a drum may require the formation of a cylindrical inner depression, and a woodwind instrument may require the shape of the inner depression to be elongated. In any case, the body portion 102 can be configured to accommodate any number of musical instruments known in the art.

Turning now to FIG. 2, the soft music instrument case 100 may include a lid 118 that enables access to the inner depression 110; and thereby the musical instrument. The lid 118 provides a protective barrier that protects and cushions the musical instrument. The lid 118, like the body portion 102, is also fabricated from a soft shell material 142. In some embodiments, the lid 118 may be hingedly or slidably connected to the body portion 102. In one embodiment, the lid 118 is displaced between an open position and a closed position to provide access to the inner depression 110.

Looking now at FIG. 4, a second embodiment 400 of the music case includes a body portion 402 shaped and dimensioned to receive a guitar. The body portion 402 include a narrow top end 412 and a wide bottom end 414. An external surface 406 is pliable, so as to comply with carry-on requirements. At least one lid 408a, 408b provides access to the interior of the body portion 402. This may include a narrow lid 408a at the top end 412 and a larger lid 408b at the wide bottom end 414. A strap and handle 410 provides a gripping surface for carrying the body portion 402. At least one fastener 404 enables zipping and unzipping the lid 408a. This guitar-shaped embodiment 400 operates substantially the same as the music case 100 described above.

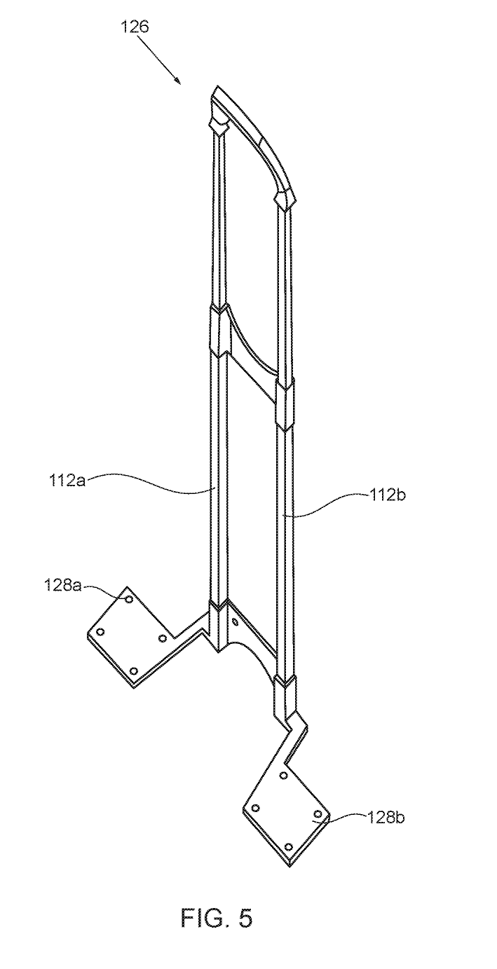

As FIG. 5 references, the music instrument case 100 also includes an instrument support frame 126 that is disposed in the inner depression 110. The instrument support frame 126 provides a rigid supportive surface that supports the music instrument; and thereby helps prevent the musical instrument from rocking or tipping over inside the body portion 102.

In one embodiment, the instrument support frame 126 is longitudinally disposed at least partially inside the body portion 102. In other embodiments, the instrument support frame 126 may be completely or partially inside the body portion 102. However in other embodiments, the instrument support frame 126 is disposed half in and half out of the body portion 102. Suitable materials for the instrument support frame 126 may include, without limitation, aluminum, steel, metal alloys, a rigid polymer, wood, and fiberglass.

The instrument support frame 126 comprises a pair of fastening support members 128a, 128b. The fastening support members 128a, 128b provide a stable surface where the mobility members, i.e., wheels or hovers or sliders or skis, are screwed into. The fastening support members 128a, 128b also include a pair of rails 112a, 112b extended across the inner or outer surface of the body portion 102.

In yet other embodiments, shown in FIG. 5, the instrument support frame 126 comprises a pair of fastening support members 128a, 128b. The fastening support members 128a-b extend perpendicular from one end of the instrument support frame 126. The fastening support members 128a-b support an external fastening brace 130 at the bottom end 122b of the body portion 102.

In some embodiments, the instrument support frame 126 further comprises a pair of rails 112a, 112b that extend across the soft inner or outer surface 108, 106 of the body portion 102. The rails 112a-b may be elongated, and extend across a substantial portion of the resilient outer surface 106; and specifically a back side of the body portion 102.

In some embodiments, the music instrument case 100 may include an arm 114 that is defined by a first end 136a and a second end 136b. The arm 114 slidably extends and retracts across the rails 112a-b, to selectively extend and retract through the body portion, and also to provide a gripping surface for carrying the music instrument case 100. In one non-limiting embodiment, the arm 114 has a telescoping configuration.

In other embodiments, a handle 120 may join the arm 114 at the first end 136a to facilitate gripping of the body portion 102 during transport. In one non-limiting embodiment, the handle 120 comprises a rectangular member that allows the hand to grasp. The handle 120 may also detach from the first end 136a of the arm 114 if necessary.

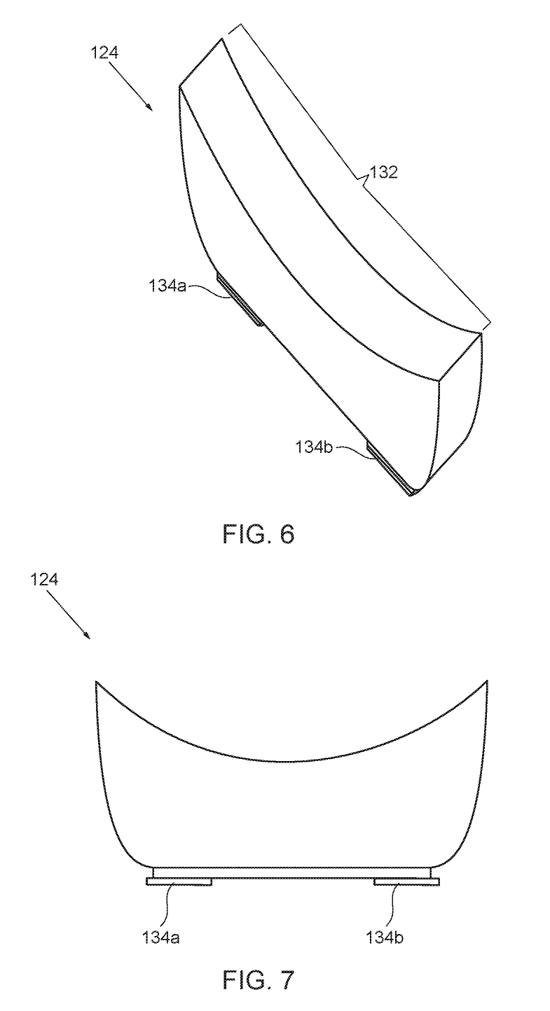

Looking now at FIG. 6, a cradle 124 rests in the inner depression 110 of the body portion 102. The cradle 124 is shaped and dimensioned to receive a musical instrument; and thereby provide a cushioned surface for the musical instrument to rest. In one embodiment, the cradle 124 comprises an arced section 132 in which the musical instrument nestles securely within. The arced section 132 can be configured to accommodate variously sized musical instruments. The cradle 124 is further defined by a pair of feet 134a, 134b that fixedly attach to the cradle, opposite the arced section 132. The feet 134a-b keep the cradle 124 level inside the body portion 102 (FIG. 7).

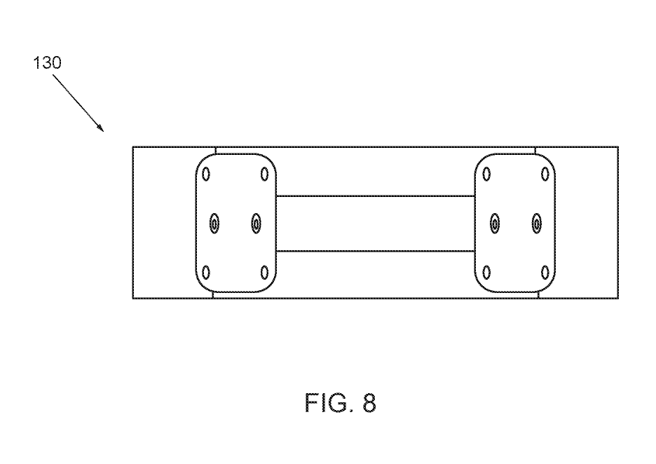

In some embodiments, the music instrument case 100 may further include a plurality of interchangeable mobility members 116a-d that detachably attach to an external fastening brace 130, which is fastened to the bottom end 122b of the body portion 102 (FIG. 8). The external fastening brace 130 may include a flat, rigid bracket defined by screw holes and ridges. The mobility members 116a-d attach to the external fastening brace 130 in a secure manner. In this manner, the mobility members 116a-d enable the body portion 102 to be pulled by the sliding arm 114 through a rolling, skidding, hovering, or matriculating motion across the ground surface.

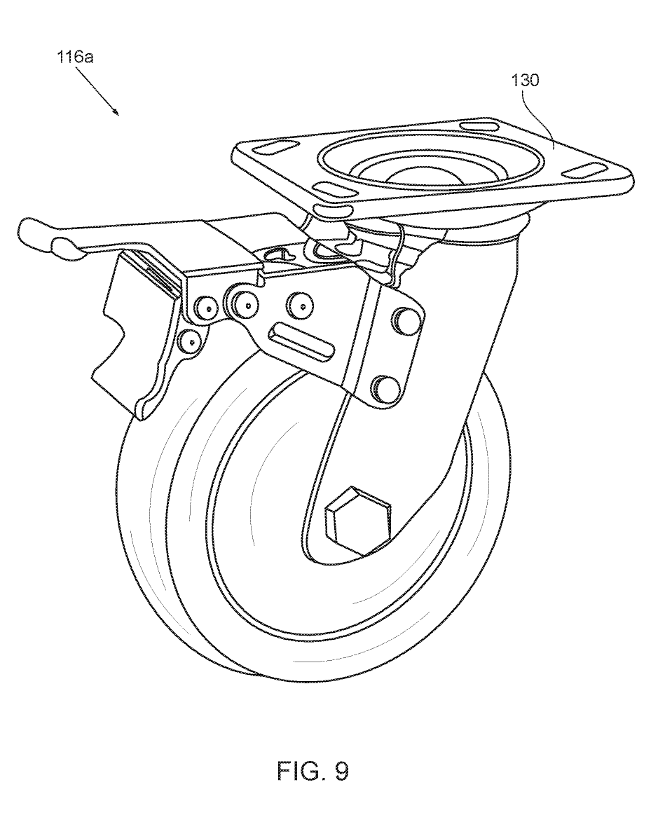

As FIGS. 9-12 show, the mobility members may be interchangeable to enable different types of mobility for different terrain. The mobility member 116a-d is configured to extend from the bottom end 122b of the body portion 102. Thus, when the body portion 102 is grasped pulled by the sliding arm 114 while rolling on the mobility member 116a-d for enhanced mobility. The mobility member 116a-d may include, without limitation, at least one wheel 116a, pair of skis 116b, one large ski, a snowboard, a hover mechanism 116c, a slide mechanism 116d, a skid, and rollers.

Looking back at FIG. 3, one possible mobility member is a pair of spaced-apart rubber wheels that roll and carry the entire body portion 102, when the body portion 102 is tilted at a 45° angle. In another embodiment of the mobility members, four 360° swivel wheels are positioned on the external fastening brace 130 outside the body portion 102. With this configuration, the tilt of 45° is not necessary, as the swivel wheels roll from any position. In yet other embodiments, any type of wheel or roller having any orientation of angle may be used to transport the body portion 102.

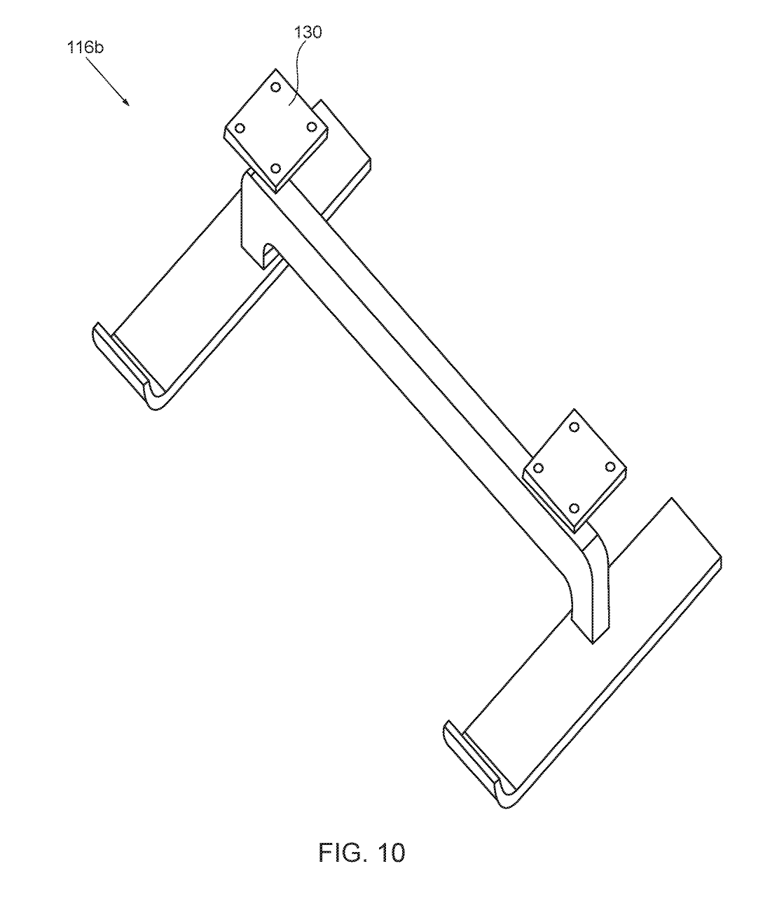

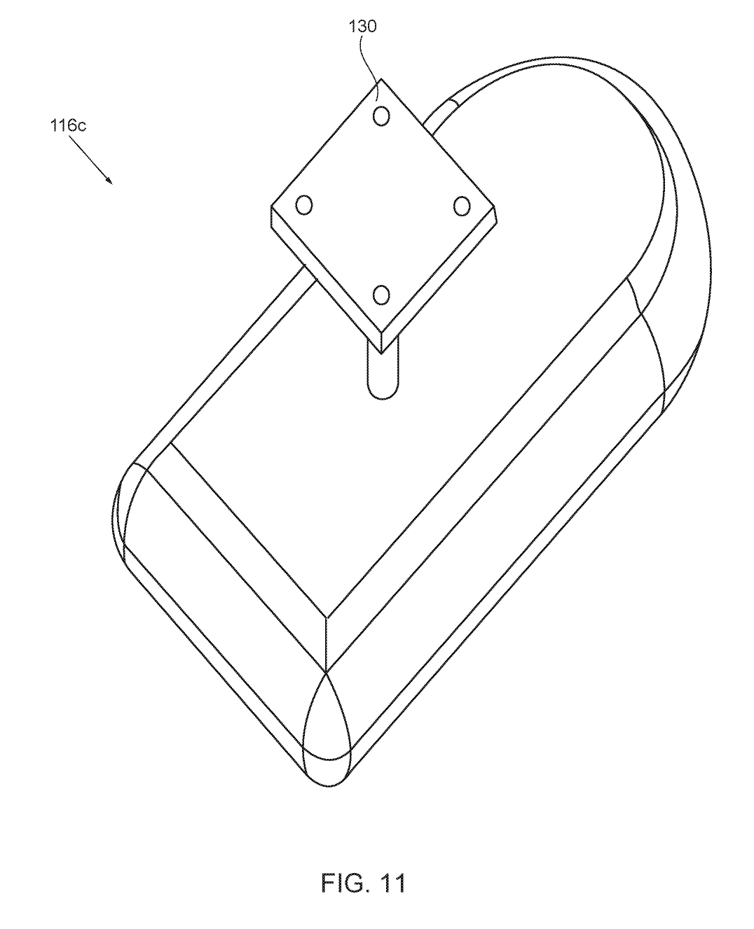

In yet other embodiments, other means for enabling mobility of the body portion 102 may be used. For example, FIG. 9 illustrates a castor wheel, representing the pair of wheels 116a. The castor wheel rolls rotates while rolling to provide the body portion 102 with a multi-directional mobility. In another example, FIG. 10 illustrates an exemplary pair of skis 116b. The skis allow the body portion 102 to glide over a surface, especially a slick surface, such as an airport terminal walkway.

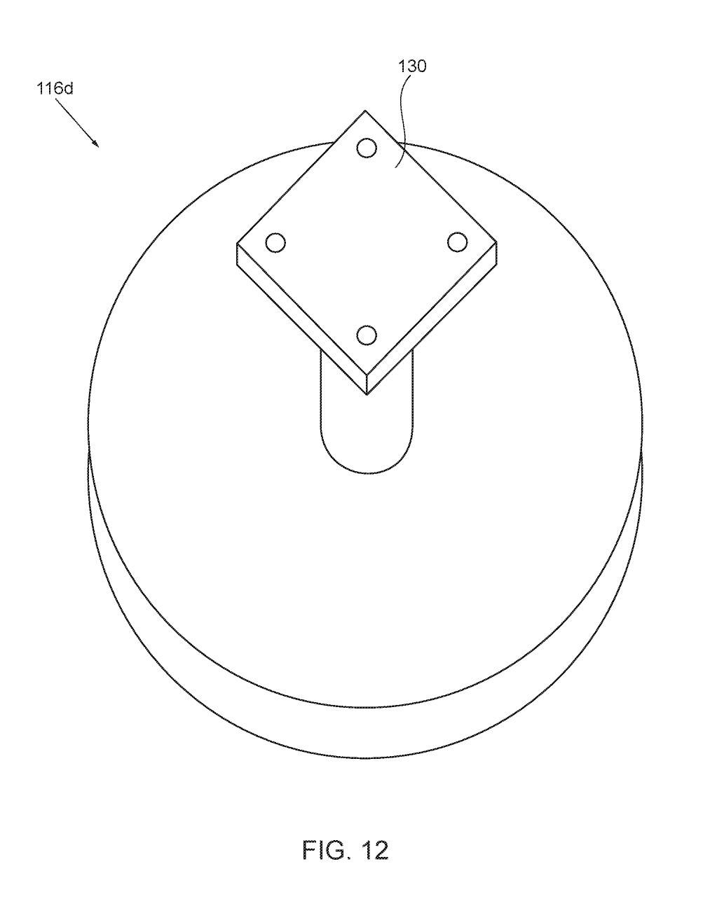

Further, FIG. 11 illustrates yet another mobility member—a hover mechanism 116c. The hover mechanism creates a hovering motion that enables motion in 360° radius. Further, FIG. 12 illustrates yet another mobility member, which is an exemplary slider mechanism 116d. The slider mechanism enables the body portion to slide across a surface.

In each type of mobility member 116a-d, detachable attachment to the external fastening brace 130, enables interchangeability (FIG. 8). To create this fastening connection, various fastening mechanisms, such as screws, nuts, and bolts may be used to secure the mobility member 116a-d to the external fastening brace 130. In one alternative embodiment, the mobility member 116a-d is fabricated from a soft material, similar to the soft shell material 142 composition of the body portion 102. However in other embodiments, the mobility member 116a-d is fabricated from a rigid material, while the body portion is pliable and acceptable for carry-on status.

In conclusion, the music instrument case 100 is defined by a pliable body 102 that receives and securely encapsulates a music instrument. The music instrument case 100 can be selected from a group consisting of: a guitar, a bass, a drum, a wind instrument, a brass instrument, a percussion instrument, a string instrument, keyboards, amplifiers, speaker, synthesizers, mixing desk, equalizer and other rack effects, Mic cable, snake cables, wireless systems, media players, subwoofer, condenser, drum Mics, wireless Mics, Mic stands, phone and tablet clips, and maintenance tools.

The music instrument case 100 comprises a soft body portion fabricated substantially from a soft shell material, including: polypropylene foam, air bladder, water bladder, soft polymer, cotton, mesh material, and flexible materials. This allows the instrument to be transported as carry-on baggage, i.e., plane. The music instrument case 100 further includes at least one mobility member, such as a wheel, a skid, and a hover mechanism, that are interchangeable and detachably attach to the body to accommodate different transport needs. A pair of rails 112a-b and a slidable arm 114 extend and retract to provide a gripping surface for facilitated transport of the music instrument case 100.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. An interchangeably portable and pliable music instrument case, the case comprising:
a pliable body portion defined by a top end, a bottom end, and a sidewall having an outer surface and an inner surface, the sidewall forming an inner depression, the body portion further being defined by a lid, the lid being displaced between an open position and a closed position to regulate access to the inner depression;
an instrument support frame disposed in the inner depression, the instrument support frame comprising a pair of fastening support members and a pair of rails;
an arm defined by a first end and a second end, the arm being extendable and retractable to selectively extend and retract through the body portion, whereby the arm enables facilitated transport of the body portion;
a cradle joined to the instrument support frame, the cradle being defined by an arced section and a pair of feet;
an external fastening brace disposed at the bottom end of the body portion; and
a plurality of mobility members being detachably attachable to the external fastening brace, the mobility members being interchangeable.

2. The case of claim 1, wherein the arced section of the cradle is shaped and dimensioned to receive a musical instrument.

3. The case of claim 2, wherein the feet of the cradle help maintain the musical instrument at a level disposition.

4. The case of claim 3, wherein the musical instrument can be selected from a group consisting of: a guitar, a bass, a drum, a wind instrument, a brass instrument, a percussion instrument, a string instrument, keyboards, amplifiers, speaker, synthesizers, mixing desk, equalizer and other rack effects, Mic cable, snake cables, wireless systems, media players, subwoofer, condenser, drum Mics, wireless Mics, Mic stands, phone and tablet clips, and maintenance tools.

5. The case of claim 1, wherein the lid is hingedly displaced between the open and closed positions.

6. The case of claim 1, wherein the lid is slidably displaced between the open and closed positions.

7. The case of claim 1, further comprising a handle, the handle joined to the first end of the arm.

8. The case of claim 1, wherein the inner depression is defined by a wide end and a narrow neck end.

9. The case of claim 1, wherein the inner depression is defined by a rectangular shape.

10. The case of claim 1, wherein the body portion comprises a soft shell material.

11. The case of claim 10, wherein the soft shell material of the body portion includes at least one of the following: a polypropylene foam, an air bladder, a water bladder, a soft polymer, cotton, a mesh material, and a flexible material.

12. The case of claim 1, wherein the mobility member includes at least one of the following: at least one wheel, a pair of skis, a hover mechanism, a slide mechanism, a skid, and rollers.

13. An interchangeably portable and pliable music instrument case, the case comprising:
a pliable body portion defined by a top end, a bottom end, and a sidewall having an outer surface and an inner surface, the sidewall forming an inner depression, the body portion further being defined by a lid, the lid being displaced between an open position and a closed position to regulate access to the inner depression, the body portion further comprising a soft shell material;
an instrument support frame disposed in the inner depression, the instrument support frame comprising a pair of fastening support members and a pair of rails;
an arm defined by a first end and a second end, the arm slidably riding the rails, the arm being extendable and retractable to selectively extend and retract through the body portion, whereby the arm enables facilitated transport of the body portion;
a handle joined to the first end of the arm;
a cradle joined to the instrument support frame, the cradle being defined by an arced section and a pair of feet;
an external fastening brace disposed at the bottom end of the body portion; and
a plurality of mobility members being detachably attachable to the external fastening brace, the mobility members being interchangeable.

14. The case of claim 13, wherein the arced section of the cradle is shaped and dimensioned to receive a musical instrument.

15. The case of claim 14, wherein the feet of the cradle help maintain the musical instrument at a level disposition.

16. The case of claim 13, wherein the lid is hingedly displaced between the open and closed positions.

17. The case of claim 13, wherein the inner depression is defined by a wide end and a narrow neck end.

18. The case of claim 13, wherein the soft shell material of the body portion includes at least one of the following: a polypropylene foam, an air bladder, a water bladder, a soft polymer, cotton, a mesh material, and a flexible material.

19. The case of claim 13, wherein the mobility member includes at least one of the following: at least one wheel, a pair of skis, a hover mechanism, a slide mechanism, a skid, and rollers.

20. An interchangeably portable and pliable music instrument case, the case consisting of:
a pliable body portion defined by a top end, a bottom end, and a sidewall having an outer surface and an inner surface, the sidewall forming an inner depression, the body portion further being defined by a lid, the lid being displaced between an open position and a closed position to regulate access to the inner depression, the body portion further comprising a soft shell material, the soft shell material including at least one of the following: a polypropylene foam, an air bladder, a water bladder, a soft polymer, cotton, a mesh material, and a flexible material;
an instrument support frame disposed in the inner depression, the instrument support frame comprising a pair of fastening support members and a pair of rails;
an arm defined by a first end and a second end, the arm slidably riding the rails, the arm being extendable and retractable to selectively extend and retract through the body portion, whereby the arm enables facilitated transport of the body portion;
a handle joined to the first end of the arm;
a cradle joined to the instrument support frame, the cradle being defined by an arced section and a pair of feet, the arced section of the cradle being shaped and dimensioned to receive a musical instrument, the feet of the cradle helping to maintain the musical instrument at a level disposition;
an external fastening brace disposed at the bottom end of the body portion; and
a plurality of mobility members being detachably attachable to the external fastening brace, the mobility members being interchangeable.
